(19) United States
(12) Patent Application Publication
(10) Pub. No.: US 2006/0167582 A1
(43) Pub. Date: Jul. 27, 2006

(54) Method of computer aided shape design

(76) Inventor: Frederic Jayko, Paris (FR)

Correspondence Address: Leo H McCormick Jr;Robert Bosch Corporation, 2112 Mishawaka Avenue, P O Box 4721, South Bend, IN, 46637, US

(21) Appl. No.: 10/535,883

(22) PCT Filed: Nov. 14, 2003
(86) PCT No.: PCT/FR03/12722

§ 371 Date: Apr. 11, 2006

(30) Foreign Application Priority Data
Nov. 22, 2002 (FR) 02 14707

(51) Int. Cl. G06F 19/00

(52) U.S. Cl. 700/182

(57) ABSTRACT

To solve a problem of functionality of components manufactured with a computer-aided design tool, a provision is made to transcode a shape (2) of the component computed by a finite element calculation and determine compatibility (6) through the use of computer-aided design software. An envelope of the shape of the component and of a deformed shape of the component is thereafter effected through a Boolean union. This Boolean union shape is compared with an available space (8) supposed to accommodate the component. The component is declared acceptable if this comparison is satisfactory.

The subject of the present invention is a method of computer-aided shape design, as well as the method of constructing a mechanical component having the shape thus designed. The aim of the invention is to render more efficient the construction of mechanical components intended to be used in more complete assemblies. In particular, the goal of the invention is the design of component parts, or of assemblies of components, integratable into a more complex device. In an example, a mechanical component investigated by the invention, also more generally referred to as an investigated physical object, will be a dashboard to be fitted into the interior of a car body. Or again, the physical object will be a braking device, in particular pneumatically boosted, to be fitted into an engine compartment of a vehicle. The aim of the invention is to take account of all the considerations and stresses affecting the physical object investigated and contributing to a modification of the footprint occupied by this physical object in the assembly with which it is integrated. The goal of the invention is essentially computer-aided design in which all these operations may be simulated.

Software for drawing components is known in the field of computer-aided design. By way of nonlimiting example, mention will be made of the CATIA software produced by the company Dassault, France, the IDEAS software produced by the company SDRC in the United States of America. Software named EUCLID, UNIGRAPHICS and PRO ENGINEER is moreover known. All of this software has in common a capability of producing numerical information able, on the one hand, to represent shapes of the physical objects computed and of presenting images of these shapes on a screen of the computer-aided design device. From the general standpoint, for the physical objects computed, involving this numerical information, it will be possible to speak of calculation of these shapes. Such a title is equivalent to a title of drawing, insofar as the shapes of these physical objects are drawn, in particular when their computation goes hand in hand with simultaneous presentation on the screen.

Moreover, such software includes control interfaces allowing the control of machine tools (most of the time multi-axis milling machines) capable of fashioning the components drawn, or even a mold for casting the component drawn. Such software makes it possible, according to a database descriptive specific thereto, to define the shapes of the physical objects computed.

From the practical standpoint, the shapes may be described in a vector manner, and more generally in the form of geometrical analytical functions, and moreover in a pointwise form, in the form of collections of clusters of points. In both cases, the geometrical loci designated in space are assigned a property of belonging or not belonging to the physical object concerned.

It is known, in respect of the calculations of the shapes of the physical objects to be integrated into a large assembly, to embark on two types of complementary investigations. A first type of investigation relates to the footprint occupied by the component at rest. In practice, the software includes intersection functions for computing a physical volume resulting from the intersection of the volume of the physical object computed and of the volume of the environment in which this physical object is intended to be inserted. If the volume of the intersection is empty, the physical object can occupy the place allocated to it. Its shape is acceptable. The problem may be made more complicated by the fitting operation which makes it necessary from a space outside the environment to calculate a route via which the physical object can be fitted within this environment. This fitting operation amounts in fact to performing the above check for a continuously variable set of positions in space of the physical object until it has reached the place allocated to it in the device.

A second type of investigation relates to the investigation of the deformations intrinsically undergone by the physical object. These deformations under stress may be related to alterations in temperature, in pressure, to the subjecting of the physical object to loads, or even to electric fields, and, in general, to any external physical action tending to deform the physical object computed. From the practical standpoint, the calculation of these deformations under stress is generally performed by a finite element calculation procedure. In practice, the physical object is thus virtually broken down into a mesh of small geometrical elements (for example tetrahedral or hexahedral elements, for example cubic elements) and stress tensors are applied to each of them so as to calculate the resultants of the deformations of the object.

Such investigations of deformation are undertaken in particular for brake calipers of a braking device which has to undergo significant loads, or even abrupt accelerations when a driver of a vehicle presses heavily on the brake pedal. In the same vein, the filling (in particular on the assembly line) of a hydraulic braking circuit of a vehicle causes the latter to undergo an overpressure (useful for avoiding the presence of air bubbles in the hydraulic circuit). This overpressure is such that this reservoir may inflate like a balloon. The finite element calculations make it possible in particular to determine the deformation of the reservoir.

However, such computer-aided design software, even when it is furnished wish a subroutine for calculating deformations by finite elements, does not make it possible to allow for the effects of the deformations undergone by the physical object when it is fitted into the device which accommodates it. For example, for the hydraulic reservoir presented hereinabove, as much as its insertion into the engine compartment of the vehicle may be possible, as much as its resistance to the overpressure may have been measured and been deemed acceptable, nevertheless, when this overpressure is applied while this reservoir is in place in this engine compartment, contact may occur between this reservoir (by inflation) and another part of the cabin which might severely modify the filling conditions to the point of robbing this item of equipment of its reliability.

The same problem may of course occur if another item of equipment neighboring the physical object investigated undergoes other stresses at the same time, which also modify the space occupancy thereof.

In the state of the art, to take account of these problems, provision is made to measure the displacement of a part of the physical object under the effect of the stresses, and to check that the displacement of this part is compatible with the space left available to accommodate this physical object. Such a course of action, carried out manually in practice requires the extraction from the finite element calculation software of a value representative of the displacement. With the help of this value, an operator checks that at the location, in the component, for which this value was extracted, the corresponding clearance is acceptable.

Such a course of action is, however, not effective enough. Situations thus appear in which, in particular on account of the complexity of shape of the components, contacts between components occur, whereas, for the mechanical component's loci for which the displacements were calculated, the compatibility of installation, the possibility of noninterference, apparently existed. The solution consisting in evaluating such values of displacement at other points of the physical object is not really practical. Specifically, on the one hand it leads to a plethora of subsequent checks (thereby delaying the end-date for the design of the physical object). On the other hand, and above all, it does not guarantee that installation will be perfect. It would have to be done for all the points of the component.

In the invention, two complementary operations are therefore conducted in order to remedy this problem. Firstly, on the basis of the deformed shape of the physical object under the effect of the stresses, which shape is calculated by the finite element calculation software, we compute a shape compatible with the processing protocol of the design software itself. We, as it were, perform a transcoding of the shape calculated in the finite element calculation software, into a shape, calculated by computer-aided design software. In a second step, a geometrical union of the shape of the starting physical object and of the deformed shape obtained on completion of the first step is effected. By doing this, we thus obtain an envelope of the various stress states: rest shape and deformed shape (possibly with several types of deformation). Then, for the installation investigation, the computed rest shape is replaced with this envelope shape, and the latter is compared with an available space in the accommodating device so as to ascertain whether said shape will still have room therein.

As a variant, if the accommodating device itself comprises physical objects that may be subjected to stresses, then the shape of this accommodating device is replaced in the computer-aided design software with the envelope shape of this accommodating device (that is to say comprising the union of the accommodating device at rest and the accommodating device having undergone stresses). By doing this it is easy to check that the draft specification of the physical object is acceptable.

As a variant, it is possible to progressively modify the shape of the physical object at rest, to calculate the deformed version of this modified shape, and to determine therefor, upon perfect comparison, what ultimate modification is the one for which a phenomenon of contact occurs with the other parts of the accommodating device.

Likewise, as a variant, rather than searching for contact, it will be possible to search for the physical object's deformations for which an existing contact, for example, relating to the presence of a compressed seal between two components, will be broken on account of the relaxing of a stress or of the deformation of a component.

As a variant, finally, it will be possible, using the method of the invention, to determine up to what level of stress the physical object computed may be subjected before contact or undesirable phenomena occur.

The invention is therefore directed at a method of computer-aided shape design, characterized in that it comprises, with the computer, the following steps:
a rest shape of a physical object is calculated with the aid of computer-aided design software,
a shape of a stressed deformed version of this physical object is calculated, the deformed version being obtained with the aid of finite element calculation software,
a shape of an envelope of the footprint of this physical object in its stress states is computed, and
the shape of the envelope of the footprint is compared with a shape of an available space.

The invention is also directed at a method of constructing a component designed according to the method of the invention.

The invention will be better understood on reading the description which follows and on examining the figures which accompany it. The latter are presented merely by way of wholly nonlimiting indication of the invention. The figures show:

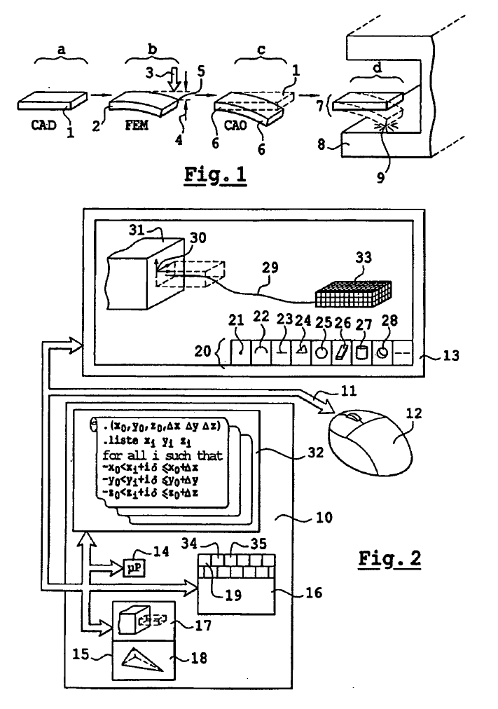

FIG. 1: a diagrammatic representation of a shape calculated according to the method of the invention, with the various calculation steps of this method;

FIG. 2: a device suitable for implementing the method of the invention.

FIG. 1 shows the various steps for computing the shape of a physical object. Calculation of the shape of a physical object is understood to mean essentially the printout, in particular in the form of a file, of the information representative of this shape. The shape of the physical object therefore exists outside of any visualization of this shape. Nevertheless, to simplify the explanation in FIG. 1, a visualization of the shape has been shown, such as it will in practice be shown on a screen of a computer-aided design device. Thus, in the course of a first step a) a computer-aided design, CAD, device is used to draw (or to calculate) a shape 1 of a physical object at rest. With the same computer, or another one, equipped with FEM finite element calculation software, in particular the first item of software cited hereinabove, it is possible in the course of a second step, b), to calculate a shape 2 of a stressed deformed version of this physical object.

The stress represented here is a mechanical stress resulting from a load 3. Of course, this stress may be of a different kind: temperature, aging, physical transformation, electric field and so on and so forth. A beam at rest and a beam having undergone bending are diagrammatically represented in the course of steps a) and b). The finite element calculation software, or a corresponding subroutine, are essentially capable of calculating deviations 4 undergone by particular points 5 of the component 1. These deviations 4 were formerly used, manually, in the state of the art to check the suitability of the components for the use for which they were intended.

According to the invention, in the course of a third step c), a shape of an envelope of the footprint of this physical object in its various stress states is computed. In practice, in the course of step c), two operations are performed. A first operation consists-in transcoding the shape computed in the course of step b) into a shape 6 (of identical shape) but expressed according to a different protocol, compatible with the design subroutine used in the course of step a). Typically, the files representative of the deformed component, output by the FEM software, of .dat (data) type, are transcoded into files that can be read and utilized by the CAD software. We shall see later how this transformation may be undertaken.

As second operation, in the course of step c), a union 7, in the Boolean sense of the term, of the volume occupied by the (newly calculated) shape 6 and of the starting shape 1 is calculated. We shall see hereinafter how the calculation of this envelope may be carried out and above all simplified. Finally, in the course of a fourth step d) according to the invention, the previously calculated envelope 7 is compared with a shape 8 intended to accommodate the component 1 and affording a space available for this purpose. The aim of the invention is to check that there is no point of contact 9 between this envelope 7 and the accommodating shape 8.

FIG. 2 shows a device usable to implement the method of the invention. This device comprises in a conventional manner a computer assembly furnished with a central processing unit 10 connected by a data and address command bus 11 to a peripheral 12 serving as man machine interface (in practice, a mouse) and to a visualization peripheral 13 (a monitor). The central processing unit 10 comprises a microprocessor 14 connected in particular by the bus 11 to a program memory 15 and to a data memory 16. The program memory 15 essentially comprises a first program 17 making it possible to implement operation a) of FIG. 1 for calculating a CAD file and a second program 18 allowing a calculation of the deformed version of step b) of FIG. 1, in particular on the basis of finite element calculations of known shapes.

With the control interface 12 an operator, physical person, is capable of constructing a shape, that is to say data records 19 storable in the memory 16. For the production of these records 19, the program 17 makes it possible, with tools 20, in particular icons visible on an edge of the screen of the monitor 13, to select preestablished elementary shapes. These preestablished elementary shapes may be points such as 21, segments 22 or 23, curves or straights, surfaces 24 or 25, here triangular or circular, or elementary volumes 26, 27, 28 respectively parallelepipedal, cylindrical or spherical, or else other shapes. Once these preestablished elementary shapes have been selected, the operator can, through a displacement 29, place them at a determined location 30 with respect to a first part 31 of an already constructed physical object. Or indeed, the elementary shape is placed at the location 30 if it is the first shape. Of course, computer-aided design software is such that the physical shapes previously computed may be reused for the design of a more significant physical object. Continuing in this way, progressively, the operator draws the physical object on the screen at the same time as the CAD software 17 constructs the corresponding file 19. Moreover, the various known software packages exhibit different possibilities of extension by homothety, of rotation and of duplication, etc. to facilitate the work of the operator. In practice, the records 19 are records representing volumes, that is to say spaces circumscribed by closed surfaces.

The records 19 and the software 17 allow the visualization of the physical object on-the monitor 13. These records 19 may be given in a vector form or in the form of clusters of points. Without entering into the details, a subroutine 32 for visualization of the assembly 10 shows that a vector representation may include, for each element 33 of the physical object to be represented, coordinates x0y0 z0 of a characteristic point (to be placed at the location 30 on the object 31) as well as values Δx Δy Δz of the expected extension of the elementary object 33. At the moment of visualization, if the software needs a numerical volume representing all the regions of the space in which the object is present, a list of points xi yi zi is calculated on the fly. If the graphics processor is not fast enough, it is possible to envisage storing these clusters of points which make it possible to define the object. A value, 1 or 0 for simplicity, is assigned to each point xi yi zi, signifying that the locus designated in the space does or does not belong to the volume of the physical object to be made. The points xi yi zi are such that with a spacing δ they concur with the constraints x0<xi+δi<x0+Δx, y0<yi+δi<y0+Δy, z0<zi+δi<z0+Δz. Of course, other file representations may be envisaged. The present representation is indicated to simplify the explanation of the invention. Each icon 21 to 28 of the man machine interface is associated with an elementary executable program, this elementary executable program receiving, as input, information regarding parameters and producing as output for visualization, on the fly, or for storage, a file of cluster coordinates of the points belonging to the elementary solid in the physical object.

The implementation of the program 18 for calculating the deformed version by finite elements amounts to breaking the object 33 down into a mesh of finite elements of given shape. The given shape of the finite elements is imposed by the FEM software. The most usual shape is the tetrahedral element. Meshing with tetrahedral elements has the advantage of being automatic. All the shapes may be meshed automatically with tetrahedra. In FIG. 2, the most practical representation of the finite elements is a hexahedral representation of the object 33. The program 18 is therefore implemented and makes it possible to compute the deviations 4 in a known manner. Although the software 18 proposes a shape, the expression of this shape is not in a format compatible with the CAD software. Typically, the FEM software 18 constructs files whose records correspond to locations of the nodes of the finite elements (four nodes in the case of a tetrahedral element) and to displacements of the nodes of each of these finite elements. The elements of the deformed structure are employed in the invention to then draw with the CAD software the shape of the deformed object, based on these locations and these displacements.

In the invention, to go from the shape 2, step b), to the shape 6, step c), an elementary volume will be created, according to the CAD software, for each of the finite elements of the deformed shape of the component. In practice, as many elementary volumes as there are finite elements that have been deformed by the stress will be calculated by CAD. Then, according to a technique already available with CAD software, all the CAD elementary volumes will be merged to produce a CAD volume 6 of the deformed component. The deformed elementary volumes are thus agglomerated.

Each of the elementary volumes can be produced with the aid of the elementary shapes of the bank 20 of elementary shapes. They are then fitted in place with respect to one another like the object 33 with respect to the object 31. In practice, this fitting into place is automatic since, each finite element having been deduced automatically from the component 2, the automatic inverse transformation is possible.

It may be admitted that the finite element calculation has led to the determination of a significant number of deformed finite elements, for example, 40 000. A calculation of 40 000 elementary volumes has thus to be done. In the invention, so as not to do this work manually, it is noted that on the one hand the shape of the finite elements that was used to evaluate the component 2 is known. In the general case they are tetrahedra. The way in which the file representative of the component 2 is constructed is also known. In the example, this file comprises 40 000 records each providing information about the coordinates in space of each of the four nodes of the tetrahedron. An elementary subroutine is then devised which is capable of constructing in the CAD software a tetrahedral elementary volume by reading a record providing information about the coordinates of the four nodes of a deformed tetrahedral finite element. Another elementary subroutine would be used if the finite element were a hexahedron, for example a cube. In order to then draw all the elementary volumes, it suffices to read a record, to run the elementary subroutine, to repeat for a subsequent record, and to merge in the sense of the drawing by CAD software, the elementary volumes obtained.

This then culminates in the definition of the shape 6, FIG. 1, given in the protocol of the software 17. Stated otherwise, one now has two records in the memory 16, a record 19 representative of the physical object at rest and a record 34 representative of the deformed shape 6 of the object 1.

In a preferred solution, to limit the calculations for reconstructing the elementary volumes, one begins by choosing those of these deformed finite elements which are on the surface of the object. One knows that a finite element is not on the surface of the object if, for example, for tetrahedral finite elements, each base or trio of its nodes is common to a first finite element and to another finite element. For a tetrahedral element, there are thus four trios (four faces) of the element to be tested each time. As a variant, one searches for the trios of nodes that are (together) attached to just a single finite element.

In practice, the elementary subroutine, which may be incorporated into the CAD software, is thereafter made to progressively read the file of deformed finite elements of the surface of the object. This reading should preferably be progressive since the transcoding occupies a great deal of random access memory resource of the drawing processor. So as not to saturate it, it is important to segment the transcoding, more exactly to regularly merge together subsets of elementary volumes obtained.

Thereafter, to ensure the consistency of reconstruction, the volume V2 of the deformed component is measured and is compared with the volume V1 of the component at rest. The known CAD software packages comprise subroutines capable of these volume calculations. Thereafter, one exploits the fact that, despite the stresses undergone, the component which is made of an incompressible material must retain an unchanged volume. If the comparison of the volumes reveals too large a deviation, for example greater than 10%, it may be deduced therefrom that the reconstruction was improper, or more simply, that the finite element calculation took into consideration finite elements of inappropriate sizes, and that it should be repeated with different, smaller sizes of finite elements.

The software 15 comprises in a known manner capabilities for effecting Boolean unions or intersections of volumes. In particular, from the practical standpoint the fusing of the elementary shape 33 with the shape 31 was equivalent to a union. In practice, the union record 35, corresponding to the union of the shape 1 (file 19) and the shape 6 (file 34), will comprise the redundant vector designations. In this case, just one of them is taken into account for the calculation of the envelope. It will also comprise additional vector designations and in this case they are all taken into consideration. In total, the shape representative of the envelope will be represented by a more significant collection 35 of vector designations, or moreover by a more significant collection of points in the cluster. Knowing moreover the definition of the space left available by the component 8 (and which may also be calculated with the program 17), one is now able to measure the intersection of the envelope 7 thus calculated with this space available in the component 8. If the intersection is null, there is no contact. If the intersection reveals the existence of points then one knows that there is contact and the component 1 is not acceptable.

Rather than taking into account for the calculation of the union of the shape of the object 1 and of the deformed shape 6, the entirety of the points of this object, it is satisfactory merely to take into consideration the calculation of the external surfaces of the physical object and of the external surfaces of the shape of the deformed version of this physical object.

Such simplifications are already available in existing software because such software makes it possible to represent views of the objects (rather than sections through these objects). Specifically, the sections through the objects comprise sets of lines showing the contours and the edges of the physical objects to be made. In certain cases, however, the drawings of these contours are not necessary and an exterior appearance alone is useful. In this case, with visualization devices it is possible to calculate the exterior surface of the object, to subject it, fictitiously, to illumination and to represent on the screen of the monitor 13, the image such as it would be visible to an operator manipulating a real component. For the present calculation of the envelope, given that the exterior surface alone is significant, one may limit oneself to the calculation of this surface. The calculations of intersections are then simpler: there is intersection as soon as the surface of the object touches the interior available space of the receptacle 8, or more simply also the surface of this receptacle 8.

By doing this one culminates in the anticipated result that the determination of the component and of its functionality is much better assessed than in the state of the art.

Furthermore, in certain cases, the available space left between the physical object and its environment is large while the definition of a larger physical object would have been more profitable in respect of the overall device to be manufactured. For example, in the case cited hereinabove, if it is possible to manufacture a larger, fatter, more robust brake caliper, it could be beneficial to do so. With the invention, one commences with a starting physical object, for example a brake caliper of given size, it is made to undergo operations a), b), c) and d), and if the comparison of step d) is favorable, one of the dimensions of this object at least (for example, the dimension Δy of the object 33) is increased and iterations a), b), c) and d) are repeated to check whether the comparison is still favorable. One proceeds thus iteratively so as to enable the shape of the physical object to be defined better. From this point of view it will be noted that a fatter physical object may undergo lesser deformations and hence that the increasing of its size will not necessarily be accompanied by an increase of the deformation 4 resulting therefrom.

Another way of seeing the problem consists in modifying the force of the load 3, or in a general manner the effect of the stress to which the object to be investigated is subjected. For example, its expansion up to a certain temperature, or up to a certain other temperature, and so on and so forth, will be investigated. With the invention, it is then possible to ascertain the stress threshold beyond which the functionality of the component is no longer acceptable.

It is thus possible by modifying the shape and by investigating the effects of the stresses, to make components that better satisfy the stipulations and specifications of the constructors.

Finally, just as, in respect of the physical object concerned, its deformed version has been investigated, so too, in respect of the space left free by the receptacle 8, it is possible to forecast what space is truly available when this receptacle 8 is itself subjected to a stress. The receptacle 8 is therefore made to undergo the same processing as for the object 1: the space available becoming smaller while the space occupied for the object 1 becomes larger.

The invention is applied to the construction of components designed according to the method described hereinabove especially in respect of the automotive field or that of aviation.

What is claimed is:

1. A method of computer-aided shape design using a computer, characterized by the following steps:
a). a rest shape (1) of a physical object is calculated with the aid of computer-aided design software (17),
b). a shape (6) of a stressed deformed version (2) of this the physical object is calculated, the deformed version being obtained with the aid of finite element calculation software (18),
c). a shape (7) of an envelope of the footprint of the physical object in its stress states is computed, and
d). the shape of the envelope of the footprint is compared (d) with a shape of an available space.

2. The method according to claim 1, characterized in that various shapes are presented as images on a screen of the computer implementing the computer-aided design software.

3. The method according to claim 1, characterized in that a first shape (2) of a deformed version of the physical object is calculated by finite element calculation, and a second shape (6) of the deformed version is calculated by calculation of elementary volumes, each elementary volume resulting from a calculation performed by the computer-aided design software of a volume of a finite element.

4. The method according to claim 3, characterized in that the calculation of the second shape of the deformed version is limited, to the calculation of external surfaces of the shape of the physical object or of the deformed shape of this physical object.

5. The method according to claim 4, characterized in that the finite elements have a tetrahedral or hexahedral shape.

6. The method according to claim 5, characterized in that a shape of the physical object is calculated, with the aid of computer-aided design software, from elementary volumes, the elementary volumes being represented by icons (21, 28) in a man machine interface of the computer-aided design software used.

7. The method according to claim 6, characterized in that each of said icons (21,28) of the man machine interface is associated with an elementary executable program, this elementary executable program receiving as input information regarding parameters and producing as output for visualization, on the fly or for storage, a file of cluster coordinates of the points belonging to the elementary volume in the physical object.

8. The method according to claim 7, characterized in that in order to compare the shape of the envelope of the footprint with a shape (8) of an available space, a geometrical intersection of the shape of the envelope of the footprint of the physical object with a shape of the footprint of neighboring physical objects is calculated.

9. The method according to claim 8, characterized in that the stresses are quantified stresses and in that a threshold stress beyond which the intersection of the shape of the envelope of the footprint of the physical object with a shape of the footprint of neighboring physical objects is not empty is determined.

10. The method according to claim 9, characterized in that the operations a) to d) are iteratively repeated while modifying the shape of the physical object until the comparison of step d) is satisfactory.

11. The method according to claim 10, characterized in that in order to compute a shape of an envelope of the footprint of this physical object in its stress state or states, a geometrical union of the shape of this physical object and of the shape of the stressed deformed version of this physical object is calculated.

12. The method according to claim 11 wherein a component is produced.
